(19) United States
(12) Patent Application Publication
(10) Pub. No.: US 2010/0259349 A1
(43) Pub. Date: Oct. 14, 2010

(54) Magnetic Film Enhanced Inductor

(75) Inventor: Xia Li, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/420,869

(22) Filed: Apr. 9, 2009

(51) Int. Cl. H01F 5/00; H01F 27/24; H01F 7/06

(52) U.S. Cl. 336/200; 336/233; 29/602.1

(57) ABSTRACT

An integrated magnetic film enhanced transformer and a method of forming an integrated magnetic film enhanced transformer are disclosed. The integrated magnetic film enhanced transformer includes an transformer metal having a first portion and a second portion, a top metal coupled to the transformer metal, a bottom metal coupled to the transformer metal, and an isolation film disposed between the first portion and the second portion of the transformer metal. The isolation film includes a magnetic material that can enhance a magnetic flux density B of the transformer, increase an electromotive force (EMF) of the transformer, and increase a magnetic permeability of the transformer.

### FIELD OF DISCLOSURE

Disclosed embodiments are related to transformers, and methods of forming transformers. More particularly, the embodiments are related to integrated magnetic film enhanced transformers, and methods of forming integrated magnetic film enhanced transformers.

### BACKGROUND

A transformer is a device that transfers electrical energy from one circuit to another circuit through a shared magnetic field. The transformer is based on two principles: first, that an electric current can produce a magnetic field (electromagnetism) and, second, that a changing magnetic field within a coil of wire induces a voltage across the ends of the coil (electromagnetic induction). By changing the current in the primary coil, the strength of the magnetic field is changed. Since the secondary coil is wrapped around the same magnetic field, a voltage is induced across the secondary coil. By adding a load to the secondary circuit, one can make current flow in the second circuit, thus transferring energy from one circuit to the other circuit.

FIGS. 1 and 2 illustrate schematic views of a simplified transformer design and circuit. In operation, a current passing through the primary coil creates a magnetic field. The primary and secondary coils are wrapped around a core of very high magnetic permeability, such as iron, which ensures that most of the magnetic field lines produced by the primary current are within the iron and pass through the secondary coil as well as the primary coil.

Such transformers can be integrated into a logic/RF CMOS process by utilizing standard CMOS back-end process steps, e.g., metal deposition, dielectric deposition, and metal patterning in the CMOS foundry. The conventional logic/RF process commonly uses an oxide or a low-k oxide as an isolation film. By integrating a transformer into a logic/RF process, a DC-DC converter and power transfer can be provided.

FIG. 3 shows a top view of a conventional cross comb type planar transformer structure. FIG. 4 shows a cross-sectional view of the cross comb type planar transformer structure illustrated in FIG. 3. The transformer can include, for example, a cross comb type transformer metal 310 connected to a bottom metal 312 by a via interconnect 314. As shown in FIG. 4, the conventional transformer commonly uses an oxide or a low-k oxide as an isolation film 308 and/or a high-k cap film 320.

### SUMMARY

Exemplary embodiments are directed to transformers, and methods of forming transformers. More particularly, the embodiments are related to integrated magnetic film enhanced transformers, and methods of forming integrated magnetic film enhanced transformers.

For example, an exemplary embodiment is directed to an integrated magnetic film enhanced transformer including a transformer metal having a first portion and a second portion, a top metal coupled to the transformer metal, a bottom metal coupled to the transformer metal, and an isolation film interposing the first portion and the second portion of the transformer metal. The isolation film includes a magnetic material.

In another exemplary embodiment, a transformer can include a substrate, a transformer metal having a plurality of turns formed on the substrate, a top metal coupled to the transformer metal, a bottom metal coupled to the transformer metal, and a magnetic material disposed between adjacent portions of the plurality of turns of the transformer metal.

In yet another exemplary embodiment, an integrated magnetic film enhanced three-dimensional circular self coupling transformer can include a transformer metal having a plurality of top metal portions, a plurality of via interconnects, and a plurality of bottom metal portions extending along a longitudinal axis of the transformer, and a magnetic material disposed between adjacent portions of the transformer metal.

Another exemplary embodiment is directed to a method of forming an integrated magnetic film enhanced transformer. The method can include forming a bottom metal, depositing and patterning a transformer metal having a first turn and a second turn, and coupled to the bottom metal, depositing and patterning a magnetic material between the first turn and the second turn of the transformer metal, and forming a top metal coupled to the transformer metal.

Another exemplary embodiment is directed to a method of forming an integrated magnetic film enhanced transformer. The method can include depositing and patterning a bottom metal using a metal deposit/photo/etching process, depositing a first inter layer dielectric (ILD) on the first metal and performing a chemical mechanical planarization (CMP) process on the inter layer dielectric, depositing a bottom cap film on the first inter layer dielectric (ILD), depositing an transformer metal on the bottom cap film and patterning the transformer metal using a photo/etching process, depositing a top cap film above the transformer metal and performing a chemical mechanical planarization (CMP) process on the top cap film, performing a photo/etching process to the top cap film to form a plurality of holes between portions of the transformer metal, depositing a magnetic material over the top cap film and the plurality of holes and etching the magnetic material back to a top of the top cap film such that the magnetic material is interposed between the portions of the transformer metal, depositing a second inter layer dielectric (ILD) above the magnetic material and performing a chemical mechanical planarization (CMP) process on the second inter layer dielectric (ILD), and performing a vertical magnetic anneal to align a magnetic field axis of the transformer along an easy axis of the magnetic material.

Another exemplary embodiment is directed to a method of forming an integrated magnetic film enhanced transformer. The method can include depositing and patterning a bottom metal using a dual damascene process, depositing a first inter layer dielectric (ILD) on the first metal, depositing a bottom cap film on the first inter layer dielectric (ILD), depositing a second inter layer dielectric (ILD) on the bottom cap film, forming a plurality of trenches in the second inter layer dielectric (ILD) using photolithography and etching techniques, plating a copper layer over at least the plurality of trenches and polishing the copper plating layer down to the surface of the second inter layer dielectric (ILD) to form an transformer metal, depositing a top cap film above the second inter layer dielectric (ILD) and the transformer metal, forming a plurality of holes in the top cap film and the second inter layer dielectric (ILD) using photolithography and etching techniques, depositing a magnetic material layer over at least the plurality of holes, depositing a third inter layer dielectric (ILD) above the magnetic material and performing a chemical mechanical planarization (CMP) process on the third inter layer dielectric (ILD), and performing a vertical magnetic anneal to align a magnetic field axis of the transformer along an easy axis of the magnetic material.

Another exemplary embodiment is directed to a transformer including transformer means for generating a magnetic field, the transformer means having a first portion and a second portion, and isolating means for magnetically isolating the first portion and the second portion of the transformer means, the isolating means interposing the first portion and the second portion of the transformer means, wherein the isolating means includes a magnetic material.

Another exemplary embodiment is directed to a method of forming a transformer. The method can include a step for depositing and patterning a transformer metal having a first portion and a second portion, and a step for depositing and patterning a magnetic material between the first portion and the second portion of the transformer metal.

### BRIEF DESCRIPTION OF THE DRAWINGS

The accompanying drawings are presented to aid in the description of embodiments and are provided solely for illustration of the embodiments and not limitation thereof.

FIG. 1 is a perspective schematic view of a conventional transformer.

FIG. 2 is a schematic of a conventional transformer circuit.

FIG. 3 is a top plan view of a conventional cross comb type planar transformer structure.

FIG. 4 is a cross-sectional view taken along line 4Y-4Y′ in FIG. 3.

FIG. 5 is a top plan view of a cross comb type planar transformer structure.

FIG. 6 is a cross-sectional view taken along line 6Y-6Y′ in FIG. 5.

FIG. 7 is a top plan view of a serpent type planar self coupling transformer structure.

FIG. 8 is a cross-sectional view taken along line 8Y-8Y′ in FIG. 7.

FIG. 9 is a top plan view of a circular type planar self coupling planar transformer.

FIG. 10 is a cross-sectional view taken along line 10Y-10Y′ in FIG. 9.

FIG. 11 is a perspective view of a three-dimensional circular self coupling transformer.

FIG. 12 is a cross-sectional view taken along line 11Y-11Y′ in FIG. 11.

FIG. 13 is a perspective view of a three-dimensional circular self coupling transformer.

FIG. 14 is a flow diagram illustrating a method of forming a transformer.

FIG. 15 is a flow diagram illustrating a method of forming a transformer.

### DETAILED DESCRIPTION

Aspects of the embodiments are disclosed in the following description and related drawings directed to such embodiments. Alternate embodiments may be devised without departing from the scope of the invention. Additionally, well-known elements used and applied in the embodiments will not be described in detail or will be omitted so as not to obscure the relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, blocks, steps, operations, elements, and/or components, but do not preclude the presence or addition of one or more other features, integers, blocks, steps, operations, elements, components, and/or groups thereof.

The disclosed exemplary embodiments are directed to transformers, and methods of forming transformers. More particularly, the embodiments are related to integrated magnetic film enhanced transformers, and methods of forming integrated magnetic film enhanced transformers. Such integrated magnetic film enhanced transformers can be used, for example, for DC-DC converters, power transfer, system on chip (SoC) with analog application, etc.

Increasing transformer efficiency and reducing size is important for circuit design and integration. Conventionally, an oxide layer is used as an isolation film, which results in a reduction in efficiency and an increase in size of the transformer. The disclosed embodiments implement a magnetic material, such as a magnetic film (e.g., a ferromagnetic film such as CoFe, CoFeB, or NiFe, etc.), instead of an oxide layer. The magnetic film can enhance a magnetic flux density B, which greatly increases the permeability and the electromotive force (EMF) of the transformer. For a given EMF of the transformer, the implementation of the magnetic film can reduce the size of the transformer and/or improve the transformer efficiency.

The disclosed embodiments recognize that the EMF of the transformer is proportional to the magnetic flux density B, turn N, and cross-section a. The magnetic flux density B is proportional to the magnetic permeability. By using a magnetic film instead of oxide, the permeability can be increased, for example, by about one hundred to one thousand times. The EMF of the transformer also can be increased by, for example, the same or similar amount. For a given EMF of the transformer, the implementation of the magnetic film can reduce the size of the transformer and/or improve the transformer efficiency.

According to the exemplary embodiments, the transformer efficiency can be improved and the size of the transformer can be reduced.

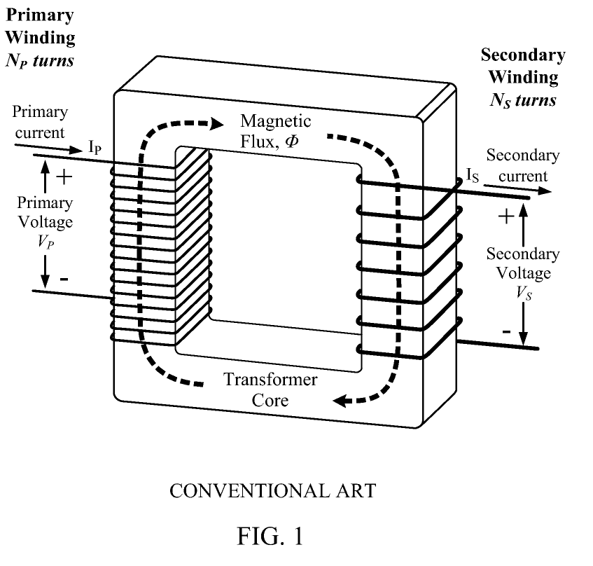

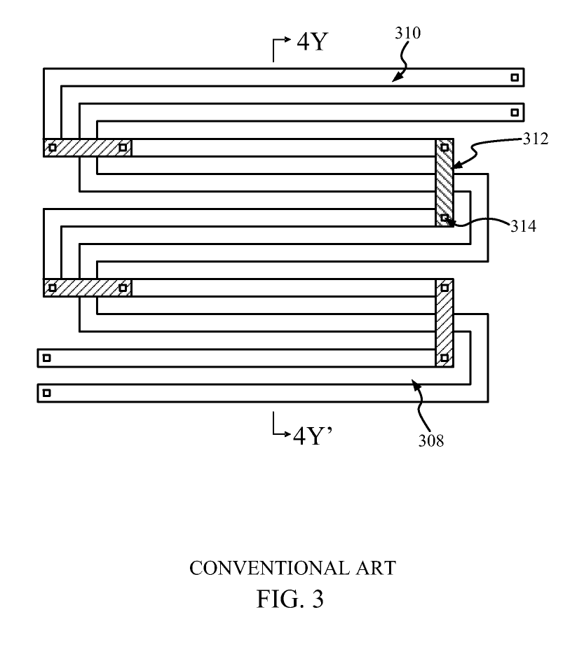

With reference to FIGS. 1-15, exemplary embodiments of an integrated magnetic film enhanced transformer, and methods of forming an integrated magnetic film enhanced transformer, will now be described.

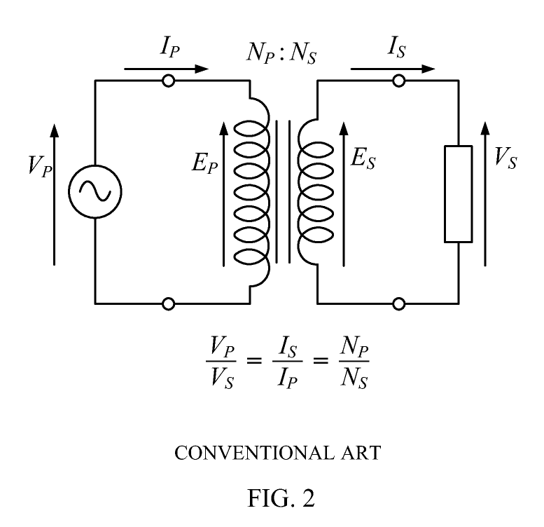

With reference again to the schematic of a transformer and circuit in FIGS. 1 and 2, one of ordinary skill in the art will recognize that a current passing through the primary coil creates a magnetic field. The primary and secondary coils are wrapped around a core of a material having very high magnetic permeability, such as iron. This ensures that most of the magnetic field lines produced by the primary current travel within the iron and pass through the secondary coil as well as the primary coil.

The voltage induced across the secondary and primary coil can be calculated from Faraday's law of induction, which states that:

$${V}_{S} = {N}_{S} \frac{d Φ}{d t} , {V}_{P} = {N}_{P} \frac{d Φ}{d t} , \frac{{V}_{S}}{{V}_{P}} = \frac{{N}_{S}}{{N}_{P}}$$

where Vs or Vp is the instantaneous voltage in the secondary or primary coils, respectively, Ns or Np is the number of turns in the secondary or primary coil and Φ equals the total magnetic flux through one turn of the coil. If the turns of the coil are oriented perpendicular to the magnetic field lines, the flux is the product of the magnetic field strength B and the area A through which it cuts. The area is constant, being equal to the cross-sectional area of the transformer core, whereas the magnetic field varies with time according to the excitation of the primary.

In an ideal transformer, all the incoming energy would be transferred from the primary circuit to the magnetic field and thence to the secondary circuit, and the following equations would be satisfied.

$${P}_{incoming} = {I}_{p} \cdot {V}_{p} = {P}_{outcoming} = {I}_{s} \cdot {V}_{s} then$$

$$\frac{{V}_{S}}{{V}_{P}} = \frac{{N}_{S}}{{N}_{P}} = \frac{{I}_{P}}{{I}_{S}}$$

Thus, if a voltage is stepped up (Vs>Vp) by the transformer, then a current is stepped down (Is<Ip) by the same factor. In practice, most transformers are very efficient, so that this formula is a good approximation.

Electromotive force (EMF) of a transformer at a given flux density increases with frequency, an effect predicted by the universal transformer EMF equation. By operating at higher frequencies, transformers can be physically more compact because a given core is able to transfer more power without reaching saturation, and fewer turns are needed to achieve the same impedance. However, properties such as core loss and conductor skin effect also increase with frequency. If the flux in the core is sinusoidal, the relationship for either winding between its root mean square EMF energy, and the supply frequency f, number of turns N, core cross-sectional area a, and peak magnetic flux density B is given by the universal EMF equation:

$$E = \frac{2 π fNaB}{\sqrt{2}} = 4.44 fNaB$$

The magnetic field of a point charge moving at constant velocity is (in SI units):

B=v×μD, B=μ₀(H+M)=μ₀(1+xₘ)H=μH

where:
v is velocity vector of the electric charge, measured in meters per second;
x indicates a vector cross product;
D is the electric displacement vector; and
μ is the magnetic permeability.

Considering the permittivity of a material, the electric displacement field is:

$$D = ɛ E , E = \frac{1}{4 π {ɛ}_{0}} \int \frac{ρ}{{r}^{2}} \hat{r} d V$$

where:
E is the electric field vector measured in newtons per coulomb or volts per meter; and
ρ is the charge density, or the amount of charge per unit volume.

Accordingly, increasing p will increase the EMF Energy of the transformer.

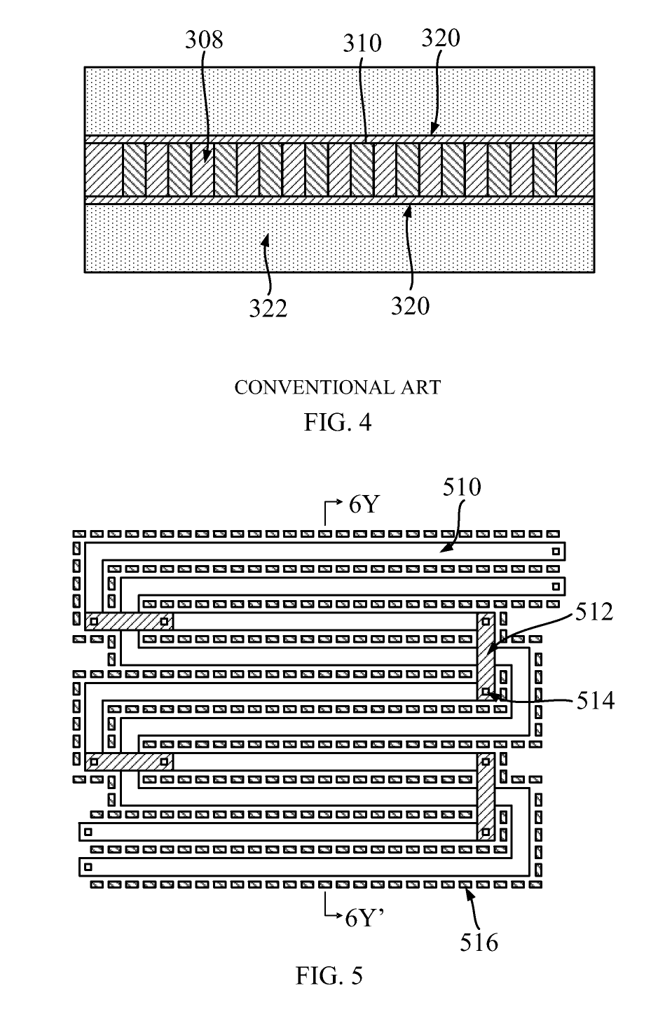

The transformer can be integrated into a logic/RF CMOS process by utilizing standard CMOS back-end process steps, e.g., metal deposition, dielectric deposition, and metal patterning in the CMOS foundry. With reference again to FIG. 4, the conventional logic/RF process commonly uses oxide or low-k oxide as an isolation film 308. By integrating the transformer into the logic/RF process, a DC-DC converter and power transfer can be provided.

In view of the above theory analysis, it will be recognized that, among other things, that the EMF of the transformer is proportional to the magnetic flux density B, number of turns N, and cross-section a. Furthermore, the magnetic flux density B is proportional to magnetic permeability.

Accordingly, by using a magnetic material, such as a magnetic film (e.g., a ferromagnetic film or thin film), instead of an oxide as the isolation film, the embodiments can increase the permeability, for example, by about one hundred to one thousand times. The embodiments also can increase the electromotive force (EMF), for example, by the same or similar amount. For a given EMF of the transformer, the implementation of a magnetic film can reduce the size of the transformer and/or increase the transformer efficiency.

An integrated magnetic field enhanced transformer according to an embodiment can be formed, for example, using two or three metal layers and one or two via logic CMOS back-end process steps, e.g., metal deposition, dielectric deposition, and metal patterning in the CMOS foundry. For example, a magnetic film can be inserted as a strip into a metal wire space to maintain a vertical anisotropic or a horizontal anisotropic of the magnetic field. It will be recognized that the magnetic material may be any suitable material, combination of materials, or alloy that exhibits magnetic properties, such as a ferromagnetic material or a ferromagnetic thin film such as CoFe, CoFeB, or NiFe, etc. Furthermore, a thickness of the magnetic material may be selected to reduce an eddy current and a skin effect inside the magnetic material to reduce magnetic field loss.

With reference to FIGS. 5-17, exemplary embodiments of an integrated magnetic film enhanced transformer, and methods of forming an integrated magnetic film enhanced transformer, will now be described.

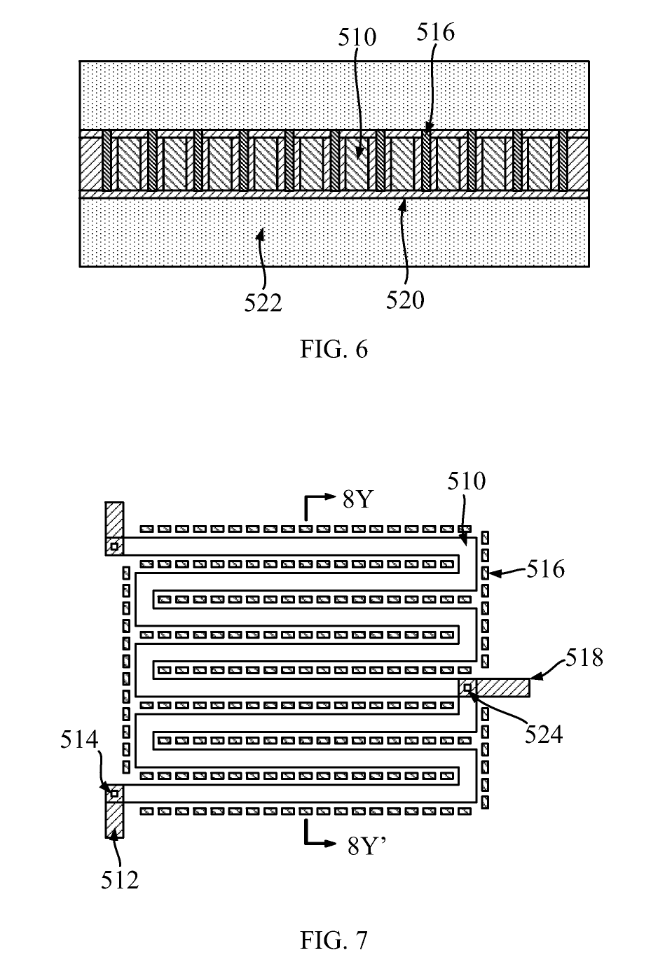

As shown in FIGS. 5 and 6, a cross comb type planar transformer structure according to an exemplary embodiment can include a cross comb type planar transformer metal 510 coupled or connected to a bottom metal 512 by via 514. A magnetic material 516, such as a magnetic film, can be inserted as a strip into one or more spaces between the transformer metal 510. As shown in the cross-sectional illustration in FIG. 6, a cap film 520 is deposited on an inter layer dielectric (ILD) 522. The transformer metal 510 is patterned on the cap film 520. The magnetic material 516 is disposed in the spaces between the transformer metal 510. That is, the magnetic material 516 interposes portions of the transformer metal 5 10. The strips of magnetic material 516 can be thin and shape anisotropic along the vertical direction or axis (i.e., the long axis of the strips, or the easy axis). The strips of magnetic material 516 can reduce the eddy current and the skin effect and enhance anisotropic magnetic flux, along with the strips inside the space of metal. According to an embodiment, the transformer efficiency can be increased and the energy loss in the magnetic films can be reduced. By using the magnetic material 516 instead of an oxide as the isolation film, the permeability can be increased, for example, by about one hundred to one thousand times. The electromotive force (EMF) also can be increased, for example, by the same or similar amount. For a given EMF of the transformer, the implementation of the magnetic material 516 can reduce the size of the transformer and/or improve the transformer efficiency.

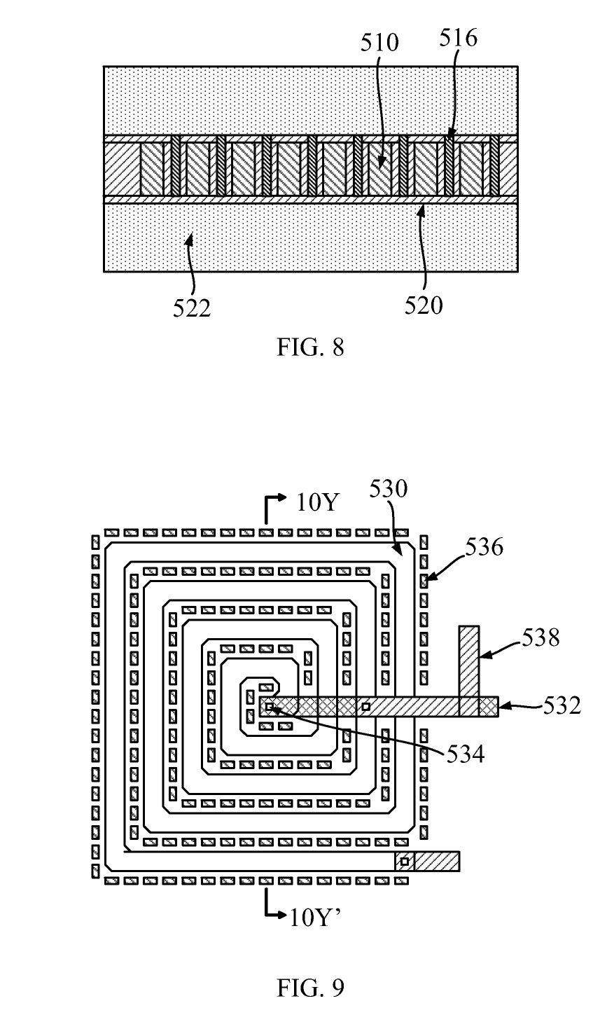

As shown in FIGS. 7 and 8, a serpent type planar self coupling transformer structure according to an exemplary embodiment can include a serpent type planar transformer metal 510 coupled or connected to a top metal 518 and bottom metal 512 by via interconnects 524 and 514. A magnetic material 516, such as a magnetic film, can be inserted as a strip into one or more spaces between the transformer metal 510. As shown in the cross-sectional illustration in FIG. 8, a cap film 520 is deposited on an inter layer dielectric (ILD) 522. The transformer metal 510 is patterned on the cap film 520. The magnetic material 516 is disposed in the spaces between the transformer metal 510. That is, the magnetic material 516 interposes portions of the transformer metal 510. By using the magnetic material 516 instead of an oxide as the isolation film, the permeability can be increased, for example, by about one hundred to one thousand times. The electromotive force (EMF) also can be increased by the same or similar amount. For a given EMF of the transformer, the implementation of the magnetic material 516 can reduce the size of the transformer and/or improve the transformer efficiency.

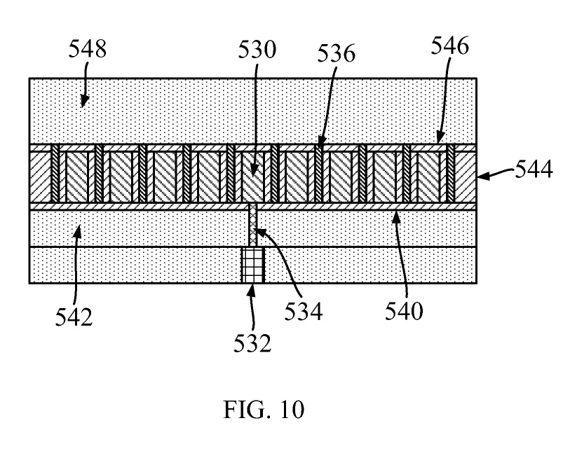

As shown in FIGS. 9 and 10, a circular type planar self coupling planar transformer structure according to an exemplary embodiment can include a circular type planar transformer metal 530 coupled or connected to a top metal 538 and bottom metal 532. As shown in the cross-sectional illustration in FIG. 10, a bottom cap film 540 is deposited on an inter layer dielectric (ILD) 542. The transformer metal 530 and dielectric 544 are deposited on the cap film 540. A top cap film 546 is deposited over the transformer metal 530 and dielectric 544. A via 534 couples or connects the bottom metal 532 to the transformer metal 530. A magnetic material 536, such as a magnetic film, can be inserted, for example, as a strip into one or more spaces between the transformer metal 530. The magnetic material 536 is disposed in the spaces between the transformer metal 530. That is, the magnetic material 536 interposes portions of the transformer metal 530. By using the magnetic material 536 instead of an oxide as the isolation film, the permeability can be increased, for example, by about one hundred to one thousand times. The electromotive force (EMF) also can be increased by the same or similar amount. For a given EMF of the transformer, the implementation of the magnetic material 536 can reduce the size of the transformer and/or increase the transformer efficiency.

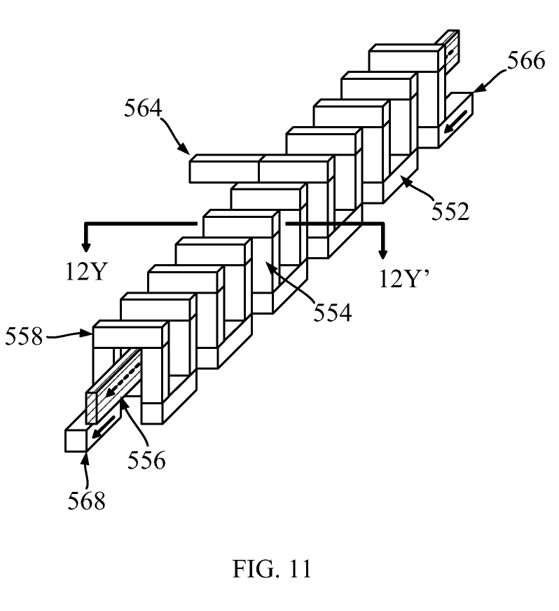

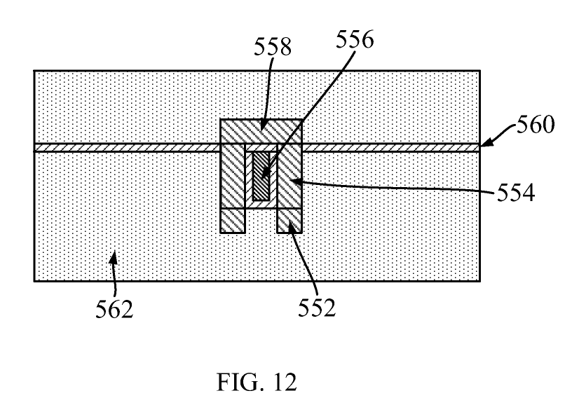

As shown in FIGS. 11 and 12, a three-dimensional circular self coupling transformer structure according to an exemplary embodiment can include a three-dimensional circular transformer metal, which includes, for example, a plurality of top metal portions 558 and bottom metal portions 552 connected by via interconnects 554. The metal portions can be formed, for example, from copper. The transformer structure includes first and second terminals 566 and 568, and an output lead 564. As shown in the cross-sectional illustration in FIG. 12, the bottom metal portions 552 can be formed in an inter layer dielectric (ILD) 562. The via interconnects 554 can be formed on the bottom metal portions 552. A cap film 560 is formed on the inter layer dielectric (ILD) 562. The top metal portions 558 can be coupled or connected to the via interconnects 554. A magnetic material 556, such as a magnetic film, can be inserted longitudinally as a strip into a space between the three-dimensional coil formed by the top metal portions 558, via interconnects 554, and bottom metal portions 552.

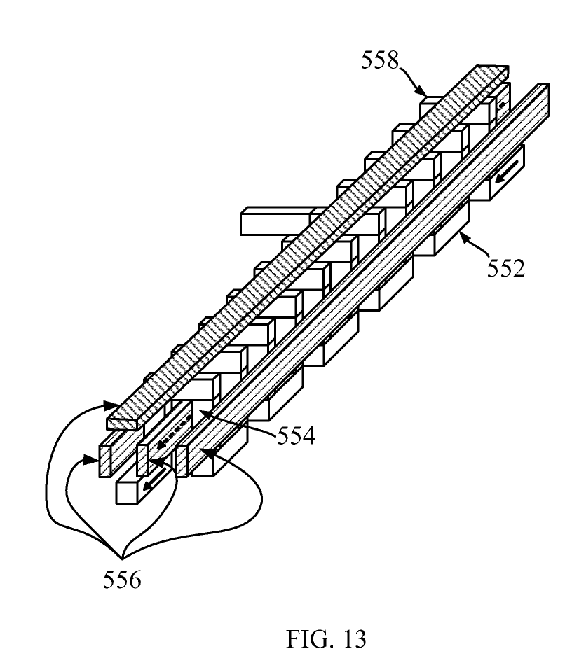

In another embodiment, the magnetic material 556 can be disposed on one or more sides of the three-dimensional coil formed by the top metal portions 558, via interconnects 554, and bottom metal portions 552, as exemplarily shown in FIG. 13.

One of ordinary skill in the art will recognize that the magnetic material 556 can be inserted longitudinally as a strip into a space between the three-dimensional coil, or disposed on one or more sides of the three-dimensional coil, as well as a combination of one or more of these features.

As shown in FIGS. 11-13, the magnetic material 556 interposes one or more portions of the transformer metal. By using the magnetic material 556 instead of an oxide as the isolation film, the permeability can be increased, for example, by about one hundred to one thousand times. By providing thin strips of magnetic material that are shape anisotropic along the vertical direction (i.e., the long axis of the strips, or the easy axis), the embodiments can reduce the eddy current and the skin effect and enhance the anisotropic magnetic flux, along with the strips inside the space of the metal. The embodiments can increase the transformer efficiency and reduce the energy loss in the magnetic films. The embodiments also can increase the electromotive force (EMF), for example, by the same or similar amount. For a given EMF of the transformer, the implementation of the magnetic material 556 can reduce the size of the transformer and/or increase the transformer efficiency.

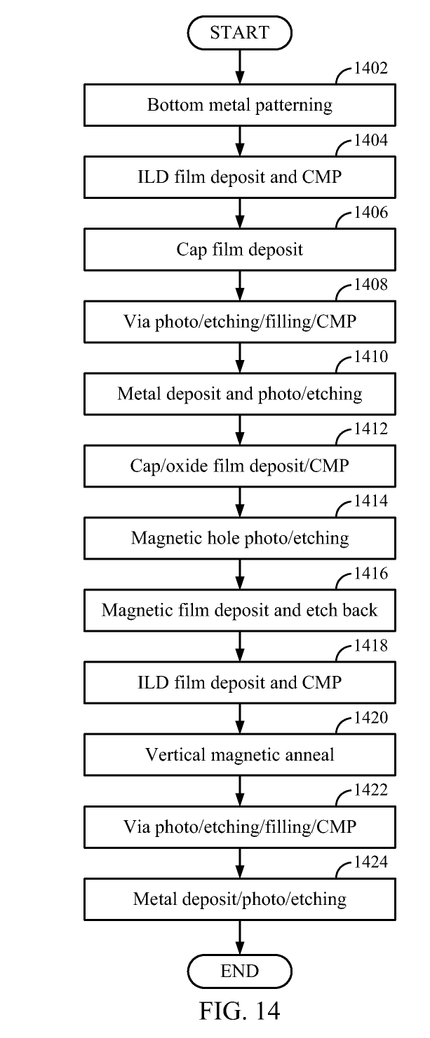

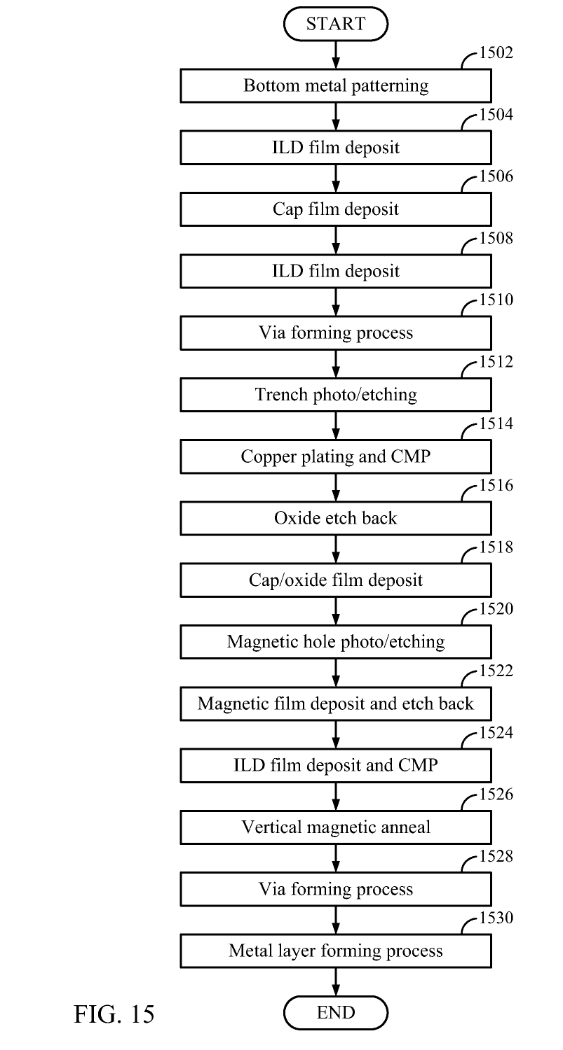

With reference to FIGS. 14 and 15, exemplary methods of forming an integrated magnetic field enhanced transformer will now be described.

FIG. 14 illustrates an exemplary method of forming an integrated magnetic field enhanced transformer according to an embodiment. A metal deposit/photo/etching process can be used to form metal wire. As explained above, an integrated magnetic field enhanced transformer can be formed, for example, using two or three metal layers (e.g., a bottom metal, a transformer metal, and/or a top metal) and one or two via logic backend processes. A magnetic material, such as a magnetic film, can be inserted as a strip into one or more spaces between the metal wire (e.g., transformer metal) to maintain a vertical anisotropic or a horizontal anisotropic of the magnetic field.

For example, with reference to FIGS. 10 and 14, an exemplary method of forming an integrated magnetic field enhanced transformer can include depositing and

Next, an ILD film can be deposited and a CMP process can be performed (e.g., 1418). A vertical magnetic anneal can be applied (e.g., 1420). A via patterning process (photo/etching) can be performed and the via can be filled, for example, by tungsten. Then, a CMP process can be performed to remove the extra tungsten on the top of the surface to form a via (not shown) (e.g., 1422). Finally, a metal film (not shown) can be deposited and the metal can be patterned by a photo/etching process to make the connection to the top via (e.g., 1424).

FIG. 15 illustrates an exemplary method of forming an integrated magnetic field enhanced transformer according to an embodiment. The method can use, for example, a dual damascene trench process to pattern a copper metal and a via. With reference to FIGS. 10 and 15, an exemplary method of forming an integrated magnetic field enhanced transformer can include using a dual damascene process, patterning trenches and plating copper and performing chemical mechanical planarization (CMP) on the bottom metal layer to form the bottom metal 532 (e.g., 1502). Next, an inter layer dielectric (ILD) 542 can be deposited (e.g., 1504). A bottom cap film 540 can be deposited on the ILD 542 (e.g., 1506). An ILD film 544 can be deposited on the bottom cap film 540 (e.g., 1508). A via opening can be formed in the ILD 542, for example, using a damascene process (e.g., 1510) and filling the via opening with metal to form a bottom via interconnect.

Next, the method can include forming trenches for metal wire using photolithography and etching techniques (e.g., 1512). The method can include plating a copper layer over at least the trenches and the vias. Then, the copper layer can be polished down to the surface of the ILD 544 using, for example, chemical mechanical planarization (CMP) techniques (e.g., 1514) to form the transformer metal 530. A exemplary method can include an oxide etching back process in ILD 544 (e.g., 1516). A top cap film 546 can be deposited on the ILD 544 and the transformer metal 530 (e.g., 1518).

A plurality of holes can be formed in the top cap film 546 and the ILD film 544 using photolithography and etching techniques (e.g., 1520). A magnetic material layer, such as a magnetic film, can be deposited over at least the etched holes, and then the magnetic material 536 can be, for example, etched back or polished using CMP techniques to the surface of the top cap film 546 to form the magnetic material 536 (e.g., 1522).

Next, an ILD film 548 can be deposited over the top cap film 546 and the magnetic material 536, and polished using, for example, chemical mechanical planarization (CMP) techniques (e.g., 1524). A vertical magnetic annealing process can be performed to align the magnetic field with the easy axis of the magnetic strips (e.g., 1526).

The method can include forming a via opening in the ILD 548, for example, using a damascene process and filling the via opening with a metal to form a via (not shown) to connect the transformer metal 530 to a top metal 538 (e.g., 1528). Finally, a metal layer (not shown) can be formed over the ILD 548 and patterned to form the top metal 538, for example, using a damascene process (e.g., 1530).

According to the features of the embodiments, an integrated magnetic field enhanced transformer, and a method of forming an integrated magnetic field enhanced transformer, can be provided, for example, for a DC-DC converter, power transfer, SoC with analog applications, etc. The embodiments implement a magnetic material, such as a magnetic film, to enhance a magnetic flux density B and increase the electromotive force (EMF) of the transformer. The magnetic strips can be shape anisotropic to increase the intrinsic magnetic field. The thickness of the magnetic strips can be reduced to provide thin magnetic strips to reduce the eddy current and the skin effect, and thereby to reduce loss of magnetic field. Since the EMF of the transformer is proportional to the magnetic flux density B, turn N, and cross-section a, and the magnetic flux density B is proportional to the magnetic permeability, the permeability can be increased, for example, by about one hundred to one thousand times, by implementing a magnetic material, such as a magnetic film, instead of oxide as an isolation film between the transformer metal portions. The EMF of the transformer also can be increased by, for example, the same or similar amount. Thus, for a given EMF of the transformer, the embodiments can reduce the size of the transformer and/or increase the transformer efficiency. It will be appreciated that the transformer, as illustrated for example in FIGS. 5-15, may be included within a mobile phone, portable computer, hand-held personal communication system (PCS) unit, portable data units such as personal data assistants (PDAs), GPS enabled devices, navigation devices, settop boxes, music players, video players, entertainment units, fixed location data units such as meter reading equipment, or any other device that stores or retrieves data or computer instructions, or any combination thereof. Accordingly, embodiments of the disclosure may be suitably employed in any device which includes active integrated circuitry including memory and on-chip circuitry for test and characterization.

The foregoing disclosed devices and methods are typically designed and are configured into GDSII and GERBER computer files, stored on a computer readable media. These files are in turn provided to fabrication handlers who fabricate devices based on these files. The resulting products are semiconductor wafers that are then cut into semiconductor die and packaged into a semiconductor chip. The chips are then employed in devices described above.

Those of skill in the art will appreciate that the disclosed embodiments are not limited to illustrated exemplary structures or methods, and any means for performing the functionality described herein are included in the embodiments.

While the foregoing disclosure shows illustrative embodiments, it should be noted that various changes and modifications could be made herein without departing from the scope of the invention as defined by the appended claims. The functions, steps and/or actions of the method claims in accordance with the embodiments described herein need not be performed in any particular order. Furthermore, although elements of the disclosed embodiments may be described or claimed in the singular, the plural is contemplated unless limitation to the singular is explicitly stated.

What is claimed is:

1. A transformer comprising:
a transformer metal having a first portion and a second portion; and
an isolation film interposing the first portion and the second portion of the transformer metal,
wherein the isolation film includes a magnetic material.

2. The integrated magnetic film enhanced transformer according to claim 1, wherein the magnetic material is a magnetic film.

3. The transformer according to claim 1, further comprising:
a top metal coupled to the transformer metal; and
a bottom metal coupled to the transformer metal.

4. The transformer according to claim 3, wherein a via interconnect couples the top metal to the transformer metal.

5. The transformer according to claim 3, wherein a via interconnect couples the bottom metal to the transformer metal.

6. The transformer according to claim 1, wherein the transformer is a cross comb type planar transformer.

7. The transformer according to claim 1, wherein the transformer is a serpent type planar self coupling transformer.

8. The transformer according to claim 1, wherein the transformer is a circular type planar self coupling transformer.

9. The transformer according to claim 1, wherein the transformer is a three-dimensional circular self coupling transformer.

10. The transformer according to claim 9, wherein the magnetic material extends along a longitudinal axis of the three-dimensional circular self coupling transformer.

11. The transformer according to claim 1 integrated in at least one semiconductor die.

12. The transformer according to claim 1, further comprising an electronic device, selected from the group consisting of a set top box, music player, video player, entertainment unit, navigation device, communications device, personal digital assistant (PDA), fixed location data unit, and a computer, into which the transformer is integrated.

13. A transformer comprising:
a substrate;
a transformer metal having a plurality of turns formed on the substrate; and
a magnetic material disposed between adjacent portions of the plurality of turns of the transformer metal.

14. The transformer according to claim 13, wherein the magnetic material is a magnetic film.

15. The transformer according to claim 13, further comprising:
a top metal coupled to the transformer metal; and
a bottom metal coupled to the transformer metal.

16. The transformer according to claim 13 integrated in at least one semiconductor die.

17. The transformer according to claim 13, further comprising an electronic device, selected from the group consisting of a set top box, music player, video player, entertainment unit, navigation device, communications device, personal digital assistant (PDA), fixed location data unit, and a computer, into which the transformer is integrated.

18. An integrated magnetic film enhanced three-dimensional circular self coupling transformer comprising:
a transformer metal having a plurality of top metal portions, a plurality of via interconnects, and a plurality of bottom metal portions extending along a longitudinal axis of the transformer; and
a magnetic material disposed between adjacent portions of the transformer metal.

19. The transformer according to claim 18, wherein the magnetic material is a magnetic film.

20. The transformer according to claim 18, wherein the magnetic material extends along the longitudinal axis of the transformer.

21. The transformer according to claim 18, wherein the plurality of top metal portions, the plurality of via interconnects, and the plurality of bottom metal portions form a plurality of U-shaped, interconnected elements extending along the longitudinal axis of the transformer.

22. The transformer according to claim 18, wherein a first top metal of the plurality of top metal portions is coupled in series to a first end of a first via interconnect of the plurality of via interconnects,
wherein a second end of the first via interconnect is coupled in series to a first end of a first bottom metal of the plurality of bottom metal portions,
wherein a second end of the first bottom metal is coupled in series to a first end of a second via interconnect of the plurality of via interconnects, and
wherein a second end of the second via interconnect is coupled in series to a first end of a second top metal of the plurality of top metal portions.

23. The transformer according to claim 22, wherein the first top metal is parallel to the second top metal,
wherein the first via interconnect is parallel to the second via interconnect,
wherein the first via interconnect and the second via interconnect are perpendicular to the first top metal and the second top metal,
wherein the first via interconnect and the second via interconnect are perpendicular to the first bottom metal, and
wherein the first bottom metal is perpendicular to each of the first via interconnect, the second via interconnect, the first top metal, and the second top metal.

24. The transformer according to claim 18 integrated in at least one semiconductor die.

25. The transformer according to claim 18, further comprising an electronic device, selected from the group consisting of a set top box, music player, video player, entertainment unit, navigation device, communications device, personal digital assistant (PDA), fixed location data unit, and a computer, into which the transformer is integrated.

26. A method of forming a transformer, the method comprising:
depositing and patterning a transformer metal having a first portion and a second portion; and
depositing and patterning a magnetic material between the first portion and the second portion of the transformer metal.

27. The method according to claim 26, wherein the magnetic material is a magnetic film.

28. The method according to claim 26, wherein the magnetic material is a shape anisotropic magnetic film.

29. The method according to claim 26, further comprising:
forming a bottom metal coupled to the transformer metal; and
forming a top metal coupled to the transformer metal.

30. The method according to claim 26, wherein a thickness of the magnetic material is selected to reduce an eddy current and a skin effect inside the magnetic material to reduce magnetic field loss.

31. The method according to claim 26, further comprising:
performing a magnetic anneal process to align a magnetic field axis of the transformer along an easy axis of the magnetic material.

32. The method according to claim 26, further comprising:
depositing a cap layer on the transformer metal to self-align the magnetic material between the first portion and the second portion of the transformer metal.

33. The method according to claim 26, wherein the transformer is applied in an electronic device, selected from the group consisting of a set top box, music player, video player, entertainment unit, navigation device, communications device, personal digital assistant (PDA), fixed location data unit, and a computer, into which the transformer is integrated.

34. A method of forming a transformer, the method comprising:
depositing and patterning a bottom metal using a metal deposit/photo/etching process;
depositing a first inter layer dielectric (ILD) on the first metal and performing a chemical mechanical planarization (CMP) process on the inter layer dielectric;
depositing a bottom cap film on the first inter layer dielectric (ILD);
depositing an transformer metal on the bottom cap film and patterning the transformer metal using a photo/etching process;
depositing a top cap film above the transformer metal and performing a chemical mechanical planarization (CMP) process on the top cap film;
performing a photo/etching process to the top cap film to form a plurality of holes between portions of the transformer metal;
depositing a magnetic material over the top cap film and the plurality of holes and etching the magnetic material back to a top of the top cap film such that the magnetic material is interposed between the portions of the transformer metal;
depositing a second inter layer dielectric (ILD) above the magnetic material and performing a chemical mechanical planarization (CMP) process on the second inter layer dielectric (ILD); and
performing a vertical magnetic anneal to align a magnetic field axis of the transformer along an easy axis of the magnetic material.

35. The method according to claim 34, further comprising:
patterning a first via opening in the first inter layer dielectric (ILD) using a photo/etching process and filling the first via opening with a metal to form a bottom via interconnect that couples the transformer metal to the bottom metal.

36. The method according to claim 34, further comprising:
depositing and patterning a top metal above the second inter layer dielectric (ILD) using a metal deposit/photo/etching process; and
patterning a second via opening in the second inter layer dielectric (ILD) using a photo/etching process and filling the second via opening with a metal to form a top via interconnect that couples the transformer metal to the top metal.

37. The method according to claim 34, wherein the magnetic material is a magnetic film.

38. The method according to claim 34, wherein the magnetic material is a shape anisotropic magnetic film.

39. The method according to claim 34, wherein a thickness of the magnetic material is selected to reduce an eddy current and a skin effect inside the magnetic material to reduce magnetic field loss.

40. The method according to claim 34, wherein the transformer is applied in an electronic device, selected from the group consisting of a set top box, music player, video player, entertainment unit, navigation device, communications device, personal digital assistant (PDA), fixed location data unit, and a computer, into which the transformer is integrated.

41. A method of forming a transformer, the method comprising:
depositing and patterning a bottom metal using a dual damascene process;
depositing a first inter layer dielectric (ILD) on the first metal;
depositing a bottom cap film on the first inter layer dielectric (ILD);
depositing a second inter layer dielectric (ILD) on the bottom cap film;
forming a plurality of trenches in the second inter layer dielectric (ILD) using photolithography and etching techniques;
plating a copper layer over at least the plurality of trenches and polishing the copper layer down to the surface of the second inter layer dielectric (ILD) to form an transformer metal;
depositing a top cap film above the second inter layer dielectric (ILD) and the transformer metal;
forming a plurality of holes in the top cap film and the second inter layer dielectric (ILD) using photolithography and etching techniques;
depositing a magnetic material layer over at least the plurality of holes;
depositing a third inter layer dielectric (ILD) above the magnetic material and performing a chemical mechanical planarization (CMP) process on the third inter layer dielectric (ILD); and
performing a vertical magnetic anneal to align a magnetic field axis of the transformer along an easy axis of the magnetic material.

42. The method according to claim 41, further comprising:
patterning a first via opening in the first inter layer dielectric (ILD) using a damascene process and filling the first via opening with a metal to form a bottom via interconnect that couples the transformer metal to the bottom metal.

43. The method according to claim 41, further comprising:
depositing and patterning a top metal above the third inter layer dielectric (ILD) using a damascene process; and
patterning a second via opening in the third inter layer dielectric (ILD) using a damascene process and filling the second via opening with a metal to form a top via interconnect that couples the transformer metal to the top metal.

44. The method according to claim 41, wherein the magnetic material is a magnetic film.

45. The method according to claim 41, wherein the magnetic material is a shape anisotropic magnetic film.

46. The method according to claim 41, wherein a thickness of the magnetic material is selected to reduce an eddy current and a skin effect inside the magnetic material to reduce magnetic field loss.

47. The method according to claim 41, wherein the transformer is applied in an electronic device, selected from the group consisting of a set top box, music player, video player, entertainment unit, navigation device, communications device, personal digital assistant (PDA), fixed location data unit, and a computer, into which the transformer is integrated.

48. A transformer comprising:
transformer means for generating a magnetic field, the transformer means having a first portion and a second portion; and
isolating means for magnetically isolating the first portion and the second portion of the transformer means, the isolating means interposing the first portion and the second portion of the transformer means,
wherein the isolating means includes a magnetic material.

49. The integrated magnetic film enhanced transformer according to claim 48, wherein the magnetic material is a magnetic film.

50. The transformer according to claim 48, further comprising:
top metal means for electrically connecting the transformer coupled to the transformer means; and
bottom metal means for electrically connecting the transformer coupled to the transformer means.

51. The transformer according to claim 50, further comprising:
first via interconnecting means for coupling the top metal means to the transformer means.

52. The transformer according to claim 50, further comprising:
second via interconnecting means for coupling the bottom metal means to the transformer means.

53. The transformer according to claim 48, wherein the transformer is a cross comb type planar transformer.

54. The transformer according to claim 48, wherein the transformer is a serpent type planar self coupling transformer.

55. The transformer according to claim 48, wherein the transformer is a circular type planar self coupling transformer.

56. The transformer according to claim 48, wherein the transformer is a three-dimensional circular self coupling transformer.

57. The transformer according to claim 56, wherein the magnetic material extends along a longitudinal axis of the three-dimensional circular self coupling transformer.

58. The transformer according to claim 48 integrated in at least one semiconductor die.

59. The transformer according to claim 48, further comprising an electronic device, selected from the group consisting of a set top box, music player, video player, entertainment unit, navigation device, communications device, personal digital assistant (PDA), fixed location data unit, and a computer, into which the transformer is integrated.

60. A method of forming a transformer, the method comprising:
step for depositing and patterning a transformer metal having a first portion and a second portion; and
step for depositing and patterning a magnetic material between the first portion and the second portion of the transformer metal.

61. The method according to claim 60, wherein the magnetic material is a magnetic film.

62. The method according to claim 60, wherein the magnetic material is a shape anisotropic magnetic film.

63. The method according to claim 60, further comprising:
step for forming a bottom metal coupled to the transformer metal; and
step for forming a top metal coupled to the transformer metal.

64. The method according to claim 60, wherein a thickness of the magnetic material is selected to reduce an eddy current and a skin effect inside the magnetic material to reduce magnetic field loss.

65. The method according to claim 60, further comprising:
performing a magnetic anneal process to align a magnetic field axis of the transformer along an easy axis of the magnetic material.

66. The method according to claim 60, further comprising:
step for depositing a cap layer on the transformer metal to self-align the magnetic material between the first portion and the second portion of the transformer metal.

67. The method according to claim 60, wherein the transformer is applied in an electronic device, selected from the group consisting of a set top box, music player, video player, entertainment unit, navigation device, communications device, personal digital assistant (PDA), fixed location data unit, and a computer, into which the transformer is integrated.
